(19) United States
(12) Patent Application Publication
(10) Pub. No.: US 2024/0427291 A1
(43) Pub. Date: Dec. 26, 2024

(54) TIMEPIECE

(71) Applicant: CASIO COMPUTER CO., LTD., Tokyo (JP)

(72) Inventors: Moeko SHIMOKAWA, Tokyo (JP); Takashi SUIZU, Tokyo (JP)

(73) Assignee: CASIO COMPUTER CO., LTD., Tokyo (JP)

(21) Appl. No.: 18/746,753

(22) Filed: Jun. 18, 2024

(30) Foreign Application Priority Data
Jun. 20, 2023 (JP) 2023-100919

(51) Int. Cl. G04B 19/04

(52) U.S. Cl. CPC G04B 19/044

(57) ABSTRACT

A timepiece according to an embodiment of the present invention includes; a first pointer; a first magnet fixed to the first pointer; a second magnet disposed to face the first magnet; a first shaft fixed to the second magnet; a gear train mechanism including a first rotary wheel interlocked with the first shaft; and a restriction member disposed to face the second magnet with the first magnet interposed therebetween.

### CROSS-REFERENCE TO RELATED APPLICATIONS

This application is based upon and claims the benefit of priority from Japanese Patent Application No. 2023-100919, filed Jun. 20, 2023, the entire contents of which are incorporated herein by reference.

### FIELD

The present invention relates generally to a timepiece.

### BACKGROUND

In a timepiece such as a wristwatch, a timepiece module including various components is housed inside a case. The timepiece module includes a dial, pointers such as a minute hand and an hour hand, a gear train mechanism, a drive source, and the like.

In a structure for supporting such pointers, for example, Jpn. Pat. Appln. KOKAI Publication No. 50-46162 discloses a mechanism including a drive magnet fixed to a distal end portion of a fourth axle and a driven magnet attached to a lower portion of a seconds hand shaft and using a magnetic force of the magnets.

### SUMMARY

A timepiece according to an embodiment of the present invention comprises; a first pointer; a first magnet fixed to the first pointer; a second magnet disposed to face the first magnet; a first shaft fixed to the second magnet; a gear train mechanism including a first rotary wheel interlocked with the first shaft; and a restriction member disposed to face the second magnet with the first magnet interposed therebetween.

### BRIEF DESCRIPTION OF THE DRAWINGS

FIG. 1 is a plan view illustrating a configuration of a timepiece according to a first embodiment.

FIG. 2 is a cross-sectional view illustrating a configuration of the timepiece.

FIG. 3 is a cross-sectional view illustrating a configuration of a pointer and a gear train mechanism of the timepiece.

FIG. 4 is an explanatory view illustrating a configuration of the pointer and a part of the gear train mechanism of the timepiece.

FIG. 5 is an explanatory view illustrating a configuration of magnets of the timepiece.

FIG. 6 is an explanatory view of a holding structure of the pointer and the part of the gear train mechanism of the timepiece.

FIG. 7 is an explanatory view illustrating a configuration of a pointer and a part of a gear train mechanism of a timepiece according to a second embodiment.

FIG. 8 is an explanatory view of a holding structure of the timepiece.

FIG. 9 is an explanatory view of a holding structure of the timepiece.

FIG. 10 is an explanatory view illustrating a configuration of a pointer and a part of a gear train mechanism of a timepiece according to a third embodiment.

FIG. 11 is an explanatory view of a holding structure of the pointer and the part of the gear train mechanism of the timepiece according to the third embodiment.

FIG. 12 is an explanatory view illustrating a configuration of a pointer and a part of a gear train mechanism of a timepiece according to a fourth embodiment.

### DETAILED DESCRIPTION

### First Embodiment

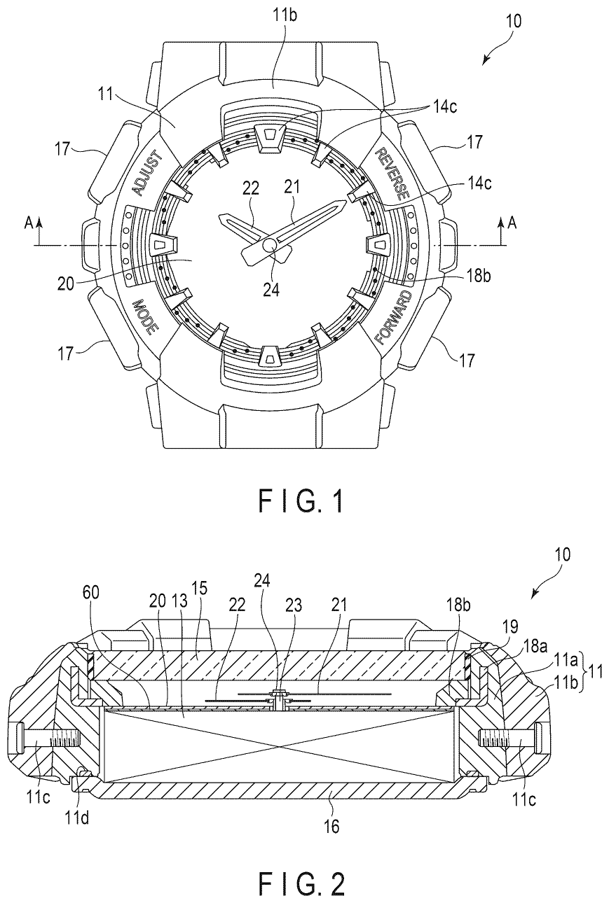

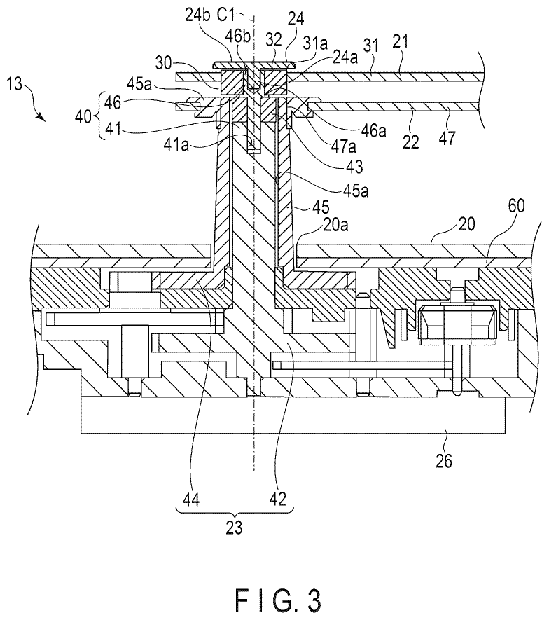

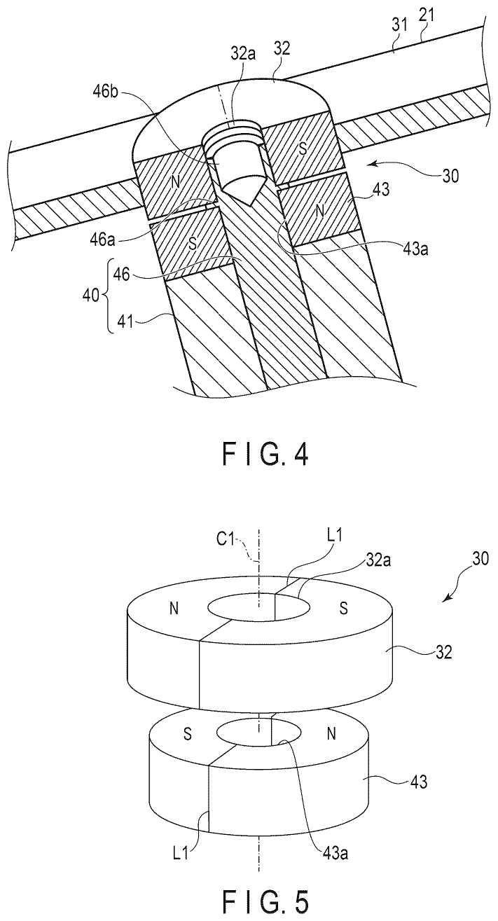

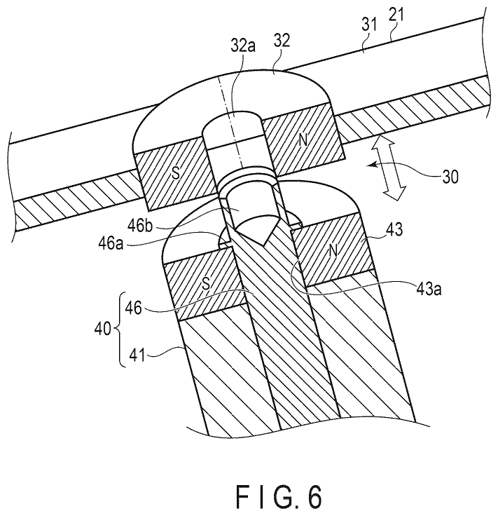

Hereinafter, a configuration of a timepiece 10 according to a first embodiment of the present disclosure will be described with reference to FIGS. 1 to 6. FIG. 1 is a plan view illustrating a configuration of the timepiece according to the first embodiment, and FIG. 2 is a cross-sectional view illustrating the configuration of the timepiece. FIG. 3 is a cross-sectional view illustrating a configuration of a pointer and a gear train mechanism of the timepiece. FIG. 4 is an explanatory view illustrating a configuration of a part of the gear train mechanism, and FIG. 5 is an explanatory view illustrating a configuration of magnets of the timepiece. FIG. 6 is an explanatory view of a holding structure. In each drawing, the configuration is schematically illustrated while being appropriately enlarged, reduced, or omitted.

As illustrated in FIGS. 1 and 2, the timepiece 10 is, for example, a wristwatch, and includes a case 11 constituting an outer frame, a timepiece module 13 provided in the case 11, a timepiece glass 15 covering a front side of the timepiece module 13, a back lid 16 covering a back side of the timepiece module 13, and one or a plurality of switches 17 arranged on an outer periphery of the case 11.

The case 11 includes an annular first case 11a and a second case 11b disposed outside the first case 11a.

The first case 11a is formed in an annular shape and has a circular accommodation space for accommodating the timepiece module 13 and the like therein.

At an upper opening of the first case 11a, a dial 20 of the timepiece module 13 is arranged. On an inner peripheral edge of the first case 11a, which is an outer peripheral portion of the dial 20, a reinforcement member 18a and an edge member 18b are disposed. In addition, a groove is formed on a surface on the back surface side (the other surface) of the first case 11a, and a waterproof ring 11d that airtightly seals the space with the back lid 16 is attached to the groove.

The second case 11b is provided on the outer periphery of the first case 11a. The second case 11b is fixed to the first case 11a by a connecting member such as a screw 11c.

The timepiece module 13 is accommodated in the accommodation space of the first case 11a. The timepiece module 13 includes the dial 20, an antimagnetic plate 60, a minute hand 21 as a first pointer, an hour hand 22 as a second pointer, a gear train mechanism 23 as a power transmission unit, a restriction member 24, and a drive source 26. In addition, the timepiece module 13 further includes various components necessary for the operation of the timepiece by a driving method, such as a battery, a circuit board on which electronic components such as an IC and an antenna are mounted.

The dial 20 is formed in a disk shape and is disposed in an upper portion in the accommodation space of the first case 11a. The dial 20 has, in a central portion, a through hole 20a into which a first shaft 40 and a second shaft 45 constituting a part of the gear train mechanism 23 are inserted. On an outer peripheral portion of a surface which is one surface side of the dial 20, the edge member 18b provided with various hour markers 14c are disposed.

The minute hand 21 includes a first pointer body 31 having a predetermined width and length. A driven magnet 32 as a first magnet is fixed to the minute hand 21.

The first pointer body 31 is configured in, for example, an elongated plate shape. A first pointer hole 31a, which is a through hole, is formed in a proximal end portion of the first pointer body 31 that rotates. The annular driven magnet 32 of the minute hand 21 is fixed to the first pointer hole 31a of the first pointer body 31. The first pointer body 31 is provided on the dial 20 in the accommodation space so as to be rotatable about a rotation axis C1.

The first pointer body 31 is connected to the drive source 26 via the gear train mechanism 23, and rotates so that the longitudinal direction thereof faces the direction corresponding to the time to be displayed.

As illustrated in FIGS. 4 and 5, the driven magnet 32 is formed in, for example, an annular shape having a shaft hole 32a (hole portion) at the center. The driven magnet 32 is made of, for example, a ferromagnetic material such as samarium cobalt. The driven magnet 32 is magnetized in the radial direction and has two poles that are different in the circumferential direction. For example, the driven magnet 32 is polarized such that one side is an S pole and the other side is an N pole with a boundary that is a radial polarization line L1 passing through the center. A support member 46, which is a part of the gear train mechanism 23, is inserted into the shaft hole 32a, and the driven magnet 32 is rotatably supported by the support member 46.

The gear train mechanism 23 includes a plurality of gear members appropriately arranged according to the arrangement of the drive source 26, the minute hand 21, and the hour hand 22. As an example, the gear train mechanism 23 includes at least a minute hand gear 42 as a first rotary wheel having the first shaft 40 engaged with the minute hand 21 and an hour hand gear 44 as a second rotary wheel having the second shaft 45 engaged with the hour hand 22. The gear train mechanism 23 constitutes, together with the drive source 26, a movement that controls the hands 21 and 22.

The minute hand gear 42 is a gear member called a second wheel, and has the first shaft 40 extending along the rotation axis C1 at the rotation center thereof. The minute hand gear 42 rotates the minute hand 21 by being rotated by the drive source 26.

The first shaft 40 includes a shaft body 41 and the support member 46 provided at a distal end of the shaft body 41. The first shaft 40 is fixed to the rotation center of the minute hand gear 42. Note that the first shaft 40 may be configured in a tubular shape having a through hole at the central portion into which another shaft member can be inserted depending on the arrangement relationship with other members. Note that the first shaft 40 may be provided integrally with the minute hand gear 42 or may be configured as a separate member. In addition, the first shaft 40 may be fixed to the minute hand gear 42 or may be configured to interlock without being fixed to the minute hand gear 42.

The shaft body 41 is a rod-shaped member extending in a predetermined first direction. A hole portion 41a into which the support member 46 is inserted and fixed is formed in a distal end part of the shaft body 41. The hole portion 41a is, for example, a bottomed recess that opens toward the tip side of the shaft body 41, that is, the front side of the timepiece 10. The support member 46 is inserted into and fixed to the hole portion 41a.

The support member 46 is a shaft member having a diameter smaller than that of the shaft body 41. The support member 46 is inserted into and fixed to the hole portion 41a of the shaft body 41, and is supported coaxially with the shaft body 41.

The support member 46 is fixed to the shaft body 41 and fixes the driven magnet 32. The support member 46 is disposed in the shaft hole 32a of the driven magnet 32 and a shaft hole 43a of a drive magnet 43. The support member 46 rotatably supports the driven magnet 32 and restricts the radial movement of the rotation of the driven magnet 32.

The support member 46 has a flange-shaped spacer 46a protruding in the outer peripheral direction at a predetermined position on the outer peripheral surface, for example. The spacer 46a is a protrusion having a predetermined thickness, and is interposed between the driven magnet 32 and the drive magnet 43 to define an axial gap between the driven magnet 32 and the drive magnet 43. For example, the thickness dimension of the spacer 46a is set to a dimension capable of securing a necessary holding force by magnetism.

The drive magnet 43 as a second magnet is press-fitted and fixed to a portion of the support member 46 on the back side of the spacer 46a, in other words, a portion between the distal end surface of the shaft body 41 and the spacer 46a. On the other hand, the driven magnet 32 is rotatably attached to a portion of the support member 46 on the front side of the spacer 46a, that is, a portion of the support member 46 on the distal end side than the spacer 46a. In other words, the spacer 46a rotatably supports the driven magnet 32 at a predetermined interval with respect to the drive magnet 43, and restricts the position of the driven magnet 32 in the radial direction.

An insertion hole 46b into which a fixing pin 24a of the restriction member 24 is inserted is formed at the distal end portion of the support member 46. The fixing pin 24a of the restriction member 24 is inserted into and fixed to the insertion hole 46b. Note that the axial dimension of the support member 46 is configured such that the distal end surface of the front end portion of the support member 46 protrudes slightly to the front side from the distal end surface of the front end portion of the driven magnet 32.

As illustrated in FIG. 4, the drive magnet 43 is formed in, for example, an annular shape having the shaft hole 43a at the center, and is disposed coaxially with the driven magnet 32. The drive magnet 43 is made of, for example, a ferromagnetic material such as samarium cobalt. The drive magnet 43 is disposed to face the back side of the driven magnet 32 across the spacer 46a in the axial direction.

The drive magnet 43 is magnetized in the radial direction and has two poles that are different in the circumferential direction. For example, the drive magnet 43 is polarized such that one side is an S pole and the other side is an N pole with a boundary that is a radial polarization line L1 passing through the center. The drive magnet 43 is pressed against and fixed to the shaft body 41 by the spacer 46a of the support member 46 press-fitted and fixed to the shaft body 41 of the first shaft 40. Further, the drive magnet 43 rotates together with the first shaft 40. The support member 46 which is a part of the first shaft 40 of the gear train mechanism 23 is disposed in the shaft hole 43a of the drive magnet 43. For example, the drive magnet 43 is fixed to the first shaft 40 by fitting or bonding. With this configuration, the drive magnet 43 is fixed with respect to the minute hand gear 42.

The drive magnet 43 is arranged to face the driven magnet 32, and holds the driven magnet 32 at a rotational position where the S poles and the N poles of the magnets are attracted to each other. Therefore, in the stationary state, the driven magnet 32 and the minute hand 21 are held in the rotation direction in which the S poles and the N poles of the magnets are attracted to each other, and the minute hand 21 rotates in synchronization with the rotation of the minute hand gear 42 during the normal hand movement of the timepiece. In other words, the drive magnet 43 and the driven magnet 32 form a magnetic holding structure 30 in a part of the gear train mechanism 23.

The hour hand 22 includes a second pointer body 47 having a predetermined width and length. For example, the second pointer body 47 is formed in a predetermined shape shorter than the first pointer body 31.

The second pointer body 47 is formed in, for example, an elongated plate shape, and has a second pointer hole 47a at a proximal end portion of the rotation. The second shaft that is a part of the gear train mechanism 23 is fixed to the second pointer hole 47a of the second pointer body 47. The second pointer body 47 is rotatably provided on the dial 20 in the accommodation space. The second pointer body 47 is connected to the drive source 26 via the gear train mechanism 23, and rotationally moves so that the longitudinal direction thereof faces the direction corresponding to the time.

The hour hand gear 44 is a gear member called an hour wheel, and integrally has the second shaft 45 extending along the rotation axis C1 at the rotation center thereof. The hour hand gear 44 rotates the hour hand 22 by being rotated by the drive source 26.

The second shaft 45 is a hollow rod-shaped member extending in a predetermined first direction. The second shaft 45 is formed in a tubular shape having, at the center, a through hole 45a into which the first shaft 40 can be inserted. The second shaft 45 is rotatably mounted on the outer periphery of the first shaft 40. The second shaft 45 is integrally provided or fixed to an axial center portion of the hour hand gear 44.

The second pointer body 47 is press-fitted and fixed to the distal end part of the second shaft 45. In other words, the second pointer body 47 rotates with the rotation of the second shaft 45.

For example, the minute hand 21, the first shaft 40, the hour hand 22, and the second shaft 45 are made of a nonmagnetic material.

As illustrated in FIG. 3, the restriction member 24 is a retaining member integrally including the fixing pin 24a and a cover portion 24b as a restricting portion. The restriction member 24 is formed of, for example, a metal material. The restriction member 24 is made of a nonmagnetic material such as brass.

The fixing pin 24a is a columnar shaft body having an outer diameter slightly larger than the insertion hole 46b formed in the support member 46 at the distal end portion of the first shaft 40, and is press-fitted and fixed to the insertion hole 46b of the support member 46. In other words, the restriction member 24 is connected to the first shaft 40 via the support member 46.

The cover portion 24b is formed in a disk shape. The cover portion 24b is integrally provided at one end portion on the proximal end side in the insertion direction of the fixing pin 24a. For example, the cover portion 24b is formed in a circular plate shape larger than the outer shape of the driven magnet 32. The cover portion 24b is arranged to face the drive magnet 43 via the driven magnet 32. The cover portion 24b is disposed on the front side of the driven magnet 32 and restricts the movement of the driven magnet 32 to the front side. In other words, the cover portion 24b is fixed, by the fixing pin 24a, to the support member 46 at the distal end portion of the first shaft 40 so that, in a case where the driven magnet 32 moves in the axial direction, the cover portion 24b interferes with the driven magnet 32 and serves as a restricting portion that restricts the position of the driven magnet 32.

The back surface (the other surface) of the cover portion 24b is arranged and positioned to face the distal end surface of the support member 46. In other words, since the axial dimension of the support member 46 is configured such that the distal end surface of the front end portion of the support member 46 protrudes slightly to the front side from the distal end surface of the front end portion of the driven magnet 32, the cover portion 24b is arranged to face the front surface of the driven magnet 32 with a slight gap interposed therebetween. Therefore, the cover portion 24b is arranged to face a position that does not hinder the rotation of the driven magnet 32.

The antimagnetic plate 60 is disposed adjacent to the dial 20 on the side opposite to the minute hand 21 as the first pointer and the hour hand 22 as the second pointer and the influence of the magnetic flux from the drive magnet 43 and the driven magnet 32 reduces the influence on the timepiece module 13. The antimagnetic plate 60 is formed in a disk shape around the through hole 20a of the dial 20. The antimagnetic plate is formed of, for example, cold-reduced carbon steel sheets and strips (SPCC) or the like. Note that the antimagnetic plate 60 may be any plate that can easily collect a magnetic field, and the material for forming the antimagnetic plate 60 is not limited to SPCC. For example, the antimagnetic plate 60 may be made of permalloy or the like.

The drive source 26 includes one or more drive mechanisms. Various drive mechanisms such as a motor and a spring mechanism can be used as the drive mechanism according to the drive system of the timepiece 10. Power may be transmitted by the gear train mechanism 23 to drive the plurality of hands 21 and 22 using one drive mechanism, or a drive mechanism may be provided for the hands 21 and 22 respectively.

The timepiece glass 15 has a so-called windshield function, and is formed in a transparent disk shape with a light transmissive material. The timepiece glass 15 is supported on the edge member 18b at the inner peripheral edge of the upper opening of the first case 11a, and covers the front side of the dial 20. For example, the timepiece glass 15 is mounted on an inner peripheral edge of the first case 11a via a gasket 19.

The switches 17 perform mode switching, time adjustment, and the like of the timepiece module 13 in a case where the operator performs a pushing operation.

In the timepiece 10 configured as described above, the minute hand 21 and a part of the gear train mechanism 23 are connected by the holding force of the magnets 32 and 43. The driven magnet 32 of the minute hand 21 is rotatably supported by the support member 46 of the first shaft 40. Therefore, the rotation of the minute hand 21 due to an external impact can be prevented from being transmitted to the first shaft 40.

In general, in a mechanism in which the magnetic force of the magnets is used for the support structure of the pointers, in a case where the timepiece receives an impact due to falling or the like, a position of the magnets may be displaced, or a repulsive force of the magnets may be generated, so that the support structure may be damaged or the pointer may be displaced.

According to the present embodiment, for example, in a case where an impact from the side direction is applied to the timepiece 10 due to falling or the like, a moment in the rotational direction is generated in the minute hand 21, but a rotational torque equal to or larger than a restraining force due to mutual magnetic forces of the drive magnet 43 and the driven magnet 32 is not applied to the minute hand gear 42. Therefore, even if the minute hand 21 rotates in a case where an impact is applied to the minute hand 21, the first shaft 40 is prevented from rotating due to the impact, so that the inside of the movement can be prevented from being broken by the rotation of the first shaft 40 caused by an external force. Furthermore, it is possible to prevent breakage of the gear due to an external force and breakage of the movement due to slip or detachment of the press-fitting and fixing portion of the pointers. In addition, for example, in a case where a motor is provided as the drive source 26, time display deviation due to step-out of a magnet of the motor can be prevented.

In addition, since the timepiece 10 includes the restriction member 24 including the restricting portion facing the drive magnet 43 with the driven magnet 32 interposed therebetween, the magnet 32 can be prevented from coming off from the shaft body 41 in a case where an impact is applied. In other words, for example, in a stationary state, the drive magnet 43 and the driven magnet 32 are arranged so as to face each other and attract each other with the S poles and the N poles of the magnets are arranged facing each other, whereby the driven magnet 32 is held. However, in a case where the positional relationship between the magnets 32 and 43 is shifted due to an impact and the repelling poles are brought into an opposing positional relationship, a repulsive force of the magnets may cause the driven magnet 32 to come out of the first shaft 40 and apply a force in a direction in which the pointer body floats. Even in such a case, since the cover portion 24b of the restriction member 24 is arranged to face the front side of the driven magnet 32, the movement of the magnet 32 can be restricted and the holding state of the magnet can be maintained.

Therefore, with the timepiece 10 according to the above embodiment, even in a case where an impact is applied and the relative positions of the drive magnet 43 and the driven magnet 32 are shifted, the positional relationship between the drive magnet 43 and the driven magnet 32 in the rotational direction is restored by the magnetic force, so that the minute hand 21 is restored to the position before the impact is applied and the time display is adjusted. Further, since the driven magnet 32 and the drive magnet 43 are arranged to face each other in the axial direction, the magnets do not interfere with each other's rotational movement.

Further, the support member 46 provided on the first shaft 40 rotatably supports the driven magnet 32 in a space-saving manner, and can restrict the positional deviation in the radial direction. The spacer 46a disposed between the driven magnet 32 and the drive magnet 43 generates a gap between the driven magnet 32 and the drive magnet 43 in the axial direction. In other words, since the friction due to the contact between the driven magnet 32 and the drive magnet 43 can be reduced, a configuration can be achieved in which the restoration of the minute hand 21 is not hindered by the frictional force generated by the contact between the driven magnet 32 and the drive magnet 43.

Note that the above-described embodiment is merely an example and does not limit the scope of the invention.

For example, according to the above embodiment, the restriction member 24 integrally including the fixing pin 24a and the cover portion 24b has been exemplified, but the configuration of the restriction member 24 is not limited to the above example.

Further, the restriction member 24 may be configured to prevent the magnet from coming off by narrowing the distance between the magnet to be restricted and the opposing member.

According to the above embodiment, the example in which the minute hand 21 and the hour hand 22 are provided as the pointers has been described, but the present invention is not limited thereto, and a pointer such as a seconds hand may be provided.

Further, in the above embodiment, the example in which the holding structure 30 by the magnets 32 and 43 is provided in the support structure of the minute hand 21 has been described; however, the present invention is not limited thereto, and a configuration with the holding structure using magnets may be applied as a support structure of an hour hand, a seconds hand, or other pointers.

### Second Embodiment

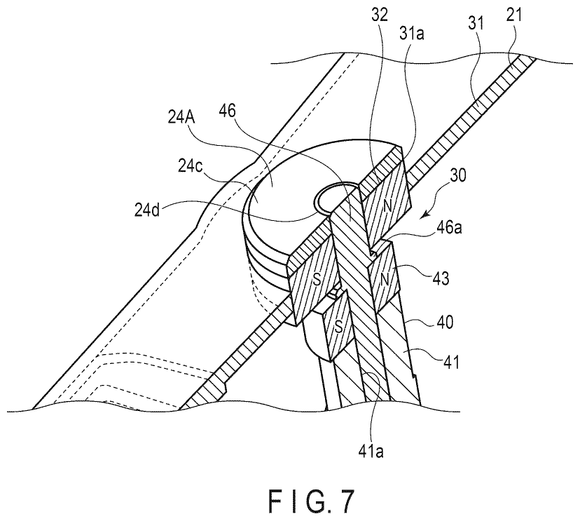

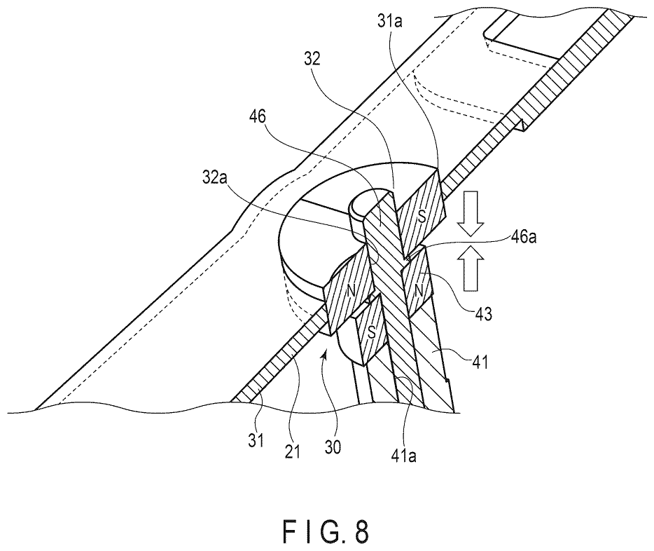

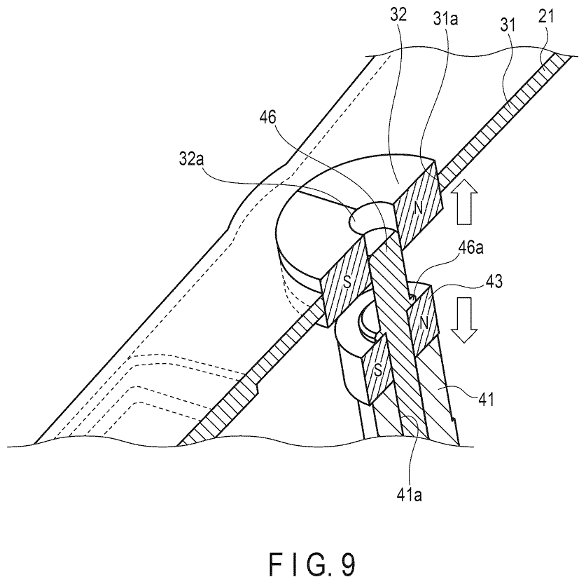

Hereinafter, a restriction member 24A according to a second embodiment will be described with reference to FIGS. 7 to 9. FIG. 7 is an explanatory view illustrating a configuration of a pointer and a part of a gear train mechanism of a timepiece according to the second embodiment. FIGS. 8 and 9 are explanatory views illustrating a holding structure 30. According to the present embodiment, the restriction member 24A includes an annular cover portion 24c. Since the other configurations are similar to those of the timepiece 10 according to the first embodiment, the description thereof will be omitted.

As illustrated in FIG. 7, the restriction member 24A includes, as the restricting portion, the cover portion 24c having a washer shape and fixed to the outer periphery of the support member 46 at the distal end of the first shaft 40. For example, the cover portion 24c is a washer member having a circular flat plate shape and having a circular hole 24d at the center. The restriction member 24A is made of a nonmagnetic material. The cover portion 24c is connected and fixed to the distal end portion of the support member 46 by press-fitting and fixing the distal end portion of the support member 46 to the central hole 24d. In other words, the restriction member 24A is connected to and fixed to the first shaft 40 via the support member 46. The upper surface of the restriction member 24A has substantially the same height as the upper surface of the support member 46. The cover portion 24c is disposed to face the drive magnet 43 with the driven magnet 32 interposed therebetween in the axial direction, and restricts the movement of the driven magnet 32 to the front side.

In other words, for example, as illustrated in FIG. 8, in the stationary state, the drive magnet 43 and the driven magnet 32 are arranged to face each other and are attracted to each other with the S poles and the N poles of the magnets arranged to face each other, whereby the driven magnet 32 is held. On the other hand, as illustrated in FIG. 9, in a case where the positional relationship between the driven magnet 32 and the drive magnet 43 is shifted due to an impact and the repelling poles face each other, a repulsive force of the magnets may apply a force in a direction in which the driven magnet 32 is removed from the first shaft 40 and the pointer body floats.

In the timepiece 10 according to the present embodiment, the restriction member 24A having the retaining portion facing the drive magnet 43 with the driven magnet 32 interposed therebetween is provided, so that the magnet 32 can be prevented from coming off from the first shaft 40 in a case where an impact is applied, and the magnet holding state can be maintained.

Therefore, with the timepiece 10 according to the above embodiment, even in a case where an impact is applied and the relative positions of the drive magnet 43 and the driven magnet 32 are shifted, the positional relationship between the drive magnet 43 and the driven magnet 32 in the rotational direction is restored by the magnetic force, so that the minute hand 21 is restored to the position before the impact is applied and the time display is adjusted.

### Third Embodiment

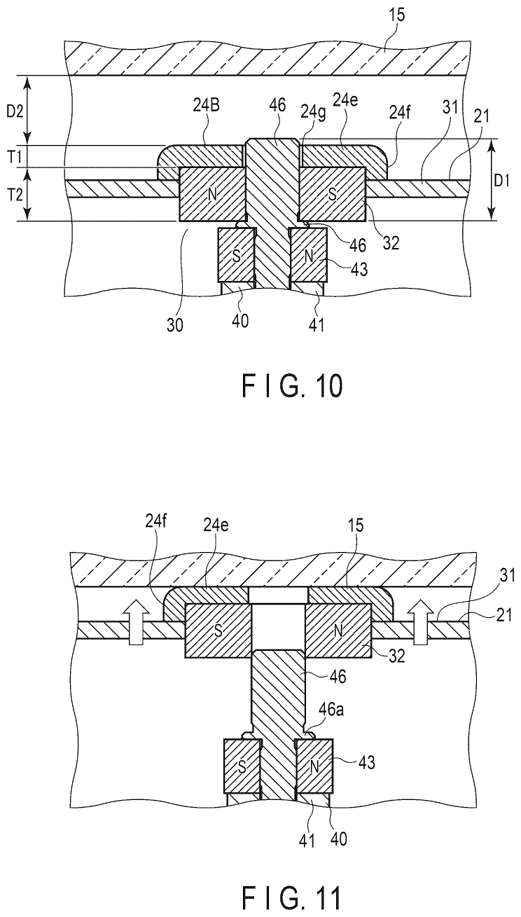

Hereinafter, a restriction member 24B according to a third embodiment will be described with reference to FIGS. 10 and 11. The restriction member 24B illustrated in FIG. 10 is a cap member integrally including a cover portion 24e arranged to face the front side of the driven magnet 32 and a peripheral wall portion 24f formed on the outer peripheral edge of the cover portion 24e.

A circular hole 24g is formed at the center of the cover portion 24e, and is formed in a circular flat plate shape. The distal end portion of the support member 46 is arranged by being inserted and fixed in the hole 24g at the center of the cover portion 24e. The diameter of the hole 24g at the center of the cover portion 24e is larger than the diameter of the support member 46. Therefore, a slight gap is formed between the cover portion 24e and the support member 46. The restriction member 24B is merely placed on the driven magnet 32, and is not fixed by press fitting or the like. However, since the restriction member 24B is made of a magnetic material and attracted to the driven magnet 32, the restriction member 24B is not detached even if the display surface of the timepiece 10 is reversed from the upper side to the lower side. In other words, the restriction member 24B is fixed to the first shaft 40 via the support member 46. The cover portion 24e has a circular outer shape larger than the outer shape of the driven magnet 32. The cover portion 24e is arranged to face the drive magnet 43 with the driven magnet 32 interposed therebetween in the axial direction, and restricts the movement of the driven magnet 32 to the front side. In other words, since the cover portion 24e is fixed to the support member 46 at the distal end portion of the first shaft 40, in a case where the driven magnet 32 moves in the axial direction, the cover portion 24e interferes with the driven magnet 32 to serve as a restricting portion that restricts the position of the driven magnet and prevents the driven magnet 32 from coming off.

The peripheral wall portion 24f is a wall-shaped member extending from the outer peripheral edge of the circular cover portion 24e to the back side, and is arranged to face the outer peripheral portion on the front side of the driven magnet 32.

The restriction member 24B is fixed to the support member 46 by press-fitting and fixing from the front side of the support member 46 and the driven magnet 32, and covers and is attached to the surface, which is one surface side, and the outer peripheral portion of the front side of the driven magnet 32.

In the cover portion 24e of the restriction member 24B, the sum of the thickness dimension T1 of the cover portion 24e and the thickness dimension T2 of the driven magnet 32 is configured to be larger than the distance D2 from the top surface of the cover portion 24e to the back surface which is the other surface side of the timepiece glass 15 which is an opposing member. In other words, the moving range in a case where the driven magnet 32 moves in the removal direction is set to be smaller than the depth dimension in which the driven magnet 32 engages with the first shaft 40.

That is, the axial dimension D2 of the gap between the end portion on the front side of the restriction member 24B and the timepiece glass 15, which is an opposing member arranged to face the front side of the restriction member 24B, is smaller than the depth dimension D1 from the proximal end portion of the driven magnet 32 to the distal end portion of the support member 46 of the first shaft 40.

In other words, in a state where the driven magnet 32 is fixed to the first shaft 40, the dimension D1 of the insertion depth, which is the distance from the distal end portion of the support member 46 that is the distal end portion of the first shaft 40, to the proximal end portion of the driven magnet 32, is configured to be larger than the dimension D2 of the gap between the restriction member 24 and the timepiece glass 15. Thus, the dimension is set such that the distance until the cover portion 24e comes into contact with the timepiece glass 15, which is an opposing member, is smaller than the distance by which the cover portion 24e moves to the distal end side in the axial direction before being detached from the first shaft 40.

Therefore, in a case where the restriction member 24B is disposed at the normal position, the insertion depth dimension D1 of the first shaft 40 is larger than the distance D2 to the timepiece glass 15 which is the opposing member. Therefore, as illustrated in FIG. 11, in a case where the driven magnet 32 moves in the direction of disengagement in the axial direction, the restriction member 24B interferes with the opposing member before the driven magnet comes off from the first shaft 40, so that the driven magnet 32 can be prevented from coming off.

Also according to the present embodiment, the cover portion 24e is arranged to face the drive magnet with the driven magnet 32 interposed therebetween in the axial direction, and the driven magnet 32 can be prevented from coming off by restricting the movement of the driven magnet 32 to the front side. Further, by making the dimension of the gap with the opposing member in the axial direction smaller than the depth dimension at which the driven magnet 32 is engaged with the first shaft 40, the driven magnet 32 can be prevented from coming off. For example, even if the cover portion 24e moves in the removal direction, the magnet 32 can be held so as not to be detached from the distal end portion of the first shaft 40. Therefore, even in a case where an impact is applied and the relative positions of the drive magnet 43 and the driven magnet 32 are shifted, the positional relationship between the drive magnet 43 and the driven magnet 32 in the rotational direction returns to the original state by the magnetic force, and thus, it is possible to obtain an effect that the minute hand 21 is restored to the position before the impact is applied and the time display is adjusted.

### Fourth Embodiment

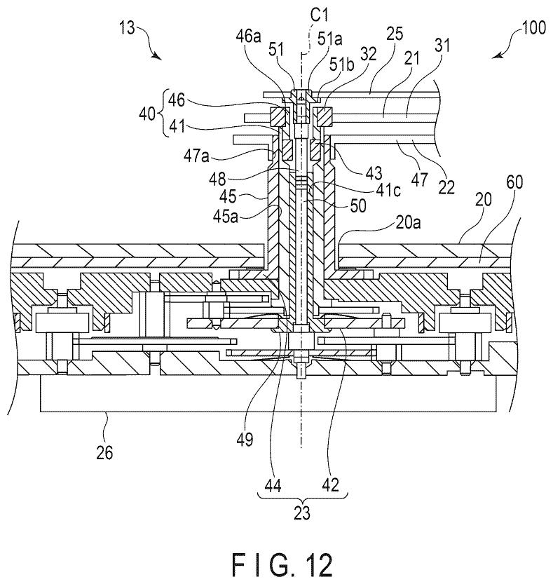

Next, a timepiece 100 according to a fourth embodiment will be described with reference to FIG. 12. The timepiece 100 according to the present embodiment includes a seconds hand 25 as a third pointer, and a seconds hand gear 49 as a third rotary wheel that drives the seconds hand 25 and includes a third shaft 48 as a part of the gear train mechanism 23. According to the present embodiment, the support member 46 is formed in a tubular shape having a hollow portion. According to the present embodiment, the support member 51 that is a part of the third shaft 48 that supports the seconds hand 25 serves as a restriction member. Other configurations are similar to those of the first embodiment.

The seconds hand gear 49 is a gear member called a fourth wheel, and integrally has the third shaft 48 extending along the rotation axis C1 at the rotation center thereof. The seconds hand gear 49 rotates the seconds hand 25 by being rotated by the drive source 26.

The third shaft 48 includes a rod-shaped shaft body 50 and a support member 51 as a restriction member provided at a distal end of the shaft body 50.

The shaft body 50 is disposed coaxially with the first shaft 40 and the second shaft 45. According to the present embodiment, the shaft body 41 of the first shaft 40 disposed at the center of the second shaft 45 is formed in a tubular shape having a hollow portion 41c, and the rod-shaped shaft body 50 is disposed in the hollow portion 41c.

The support member 51 includes a cylindrical fixing portion 51a press-fitted and fixed to the seconds hand 25, and a restricting portion 51b arranged to face the front side of the driven magnet 32. The support member 51 is fixed to the seconds hand 25. The restricting portion 51b is formed in a flange shape in which a part of the outer peripheral surface of the cylindrical fixing portion 51a protrudes radially outward. The restricting portion 51b is disposed between the seconds hand 25 and the driven magnet 32 in the axial direction. The restricting portion 51b is arranged to face the front side of the driven magnet 32, and constitutes a retaining member that restricts the position of the driven magnet 32 by interfering with the driven magnet 32 in a case where the driven magnet 32 moves to the front side.

The seconds hand 25 is disposed on the front side of the minute hand 21 and the hour hand 22, and rotates together with the seconds hand gear 49. In order to suppress the influence of magnetism, the seconds hand 25, the shaft body 50 of the third shaft 48, and the support member 51 are made of a nonmagnetic material having hardness that can withstand the load of press-fitting for fixing the seconds hand 25.

According to the present embodiment, the support member 46 of the first shaft 40 has a tubular shape, and the shaft body 50 of the third shaft 48 can be inserted and fixed to the hollow portion of the first shaft 40. The support member 46 includes a spacer 46a having a step for rotatably holding the driven magnet 32. Other configurations are similar to those of the first embodiment.

Also according to the present embodiment, the same effects as those of the first embodiment are obtained. In other words, since the timepiece 100 includes the support member 51 having the restricting portion 51b facing the drive magnet 43 with the driven magnet 32 interposed therebetween, the magnet 32 can be prevented from coming off from the shaft body 41 in a case where an impact is applied. Therefore, the movement of the driven magnet 32 can be restricted by the restricting portion 51b arranged to face the front side of the magnet 32 as a part of the support member that supports the seconds hand 25, and the holding state can be maintained. Furthermore, since the minute hand 21 and the gear train mechanism 23 are connected by the holding force of the magnets, transmission of an impact from the outside can be suppressed. In addition, by using a nonmagnetic material for the seconds hand 25, the shaft body 50 of the third shaft 48, and the support member 51, the influence of the magnetic force can be suppressed and the pointers can be normally operated.

Note that the features of the plurality of embodiments described above may be combined. For example, in the timepiece 10 according to the first embodiment, the axial dimension of the gap between the restriction member 24 and the timepiece glass 15 that is an opposing member is configured to be smaller than the depth dimension at which the restriction member 24 is engaged with the first shaft 40, that is, the distance from the end portion on the proximal end side of the restriction member 24 to the position of the distal end of the support member 46 on the distal end side of the first shaft 40, so that the retaining effect can be improved.

According to the above embodiment, the seconds hand 25, which is the third pointer, and the third shaft 48 are made of a nonmagnetic material, but the present invention is not limited thereto. In place of or in addition to the seconds hand 25 and the third shaft 48, another member may be made of a nonmagnetic material. For example, at least one of the minute hand 21, the first shaft 40, the hour hand 22, the second shaft 45, the seconds hand 25, and the third shaft 48, or other peripheral members may be made of a nonmagnetic material.

According to each of the above embodiments, the example in which the holding structure by the magnets 32 and 43 is provided in the support structure of the minute hand 21 has been described, but the present invention is not limited thereto, and a configuration in which the holding structure by the magnets is provided may be applied as the support structure of the hour hand, the seconds hand, and other pointers.

For example, the example in which the drive magnet 43 and the driven magnet 32 are made of a hard magnetic material has been described, but the present invention is not limited thereto. For example, one of them may be made of a soft magnetic material.

Although some embodiments of the present disclosure have been described, the present disclosure is included in the invention described in the claims and the equivalent scope thereof.

What is claimed is:

1. A timepiece comprising:
a first pointer;
a first magnet fixed to the first pointer;
a second magnet disposed to face the first magnet;
a first shaft fixed to the second magnet;
a gear train mechanism including a first rotary wheel interlocked with the first shaft; and
a restriction member disposed to face the second magnet with the first magnet interposed therebetween.

2. The timepiece according to claim 1, wherein the restriction member is fixed to the first shaft.

3. The timepiece according to claim 1, wherein
the second magnet holds the first magnet by magnetic force, and
the first magnet and the second magnet are magnets configured in a circular shape and polarized in a circumferential direction of rotation.

4. The timepiece according to claim 1, wherein the first magnet and the second magnet are arranged to face each other in an axial direction.

5. The timepiece according to claim 1, wherein
the first magnet and the second magnet are formed in an annular shape having a hole portion at the center,
the first shaft includes a shaft body and a support member provided at a distal end portion of the shaft body,
the support member is disposed in the hole portion, rotatably supports the first magnet with respect to the shaft body, and restricts radial movement of rotation of the first magnet, and
the restriction member is fixed to a distal end portion of the support member.

6. The timepiece according to claim 5, wherein the restriction member comprises a cover portion disposed on a front surface side of the first magnet, and a pin connected to a back surface side of the cover portion and fixed to the distal end portion of the support member.

7. The timepiece according to claim 6, wherein the cover portion is disposed to face the front surface side of the first magnet with a gap interposed therebetween.

8. The timepiece according to claim 1, wherein
the restriction member comprises a restricting portion fixed to the first shaft and disposed on a front surface side of the first magnet, and
an axial dimension of a gap between the restriction member and an opposing member disposed to face a front surface side of the restriction member is smaller than an axial dimension from a proximal end portion of the first magnet to a distal end portion of the first shaft.

9. The timepiece according to claim 1, further comprising
a second pointer, wherein
the gear train mechanism comprises a second rotary wheel having a second shaft to which the second pointer is fixed, and
the first shaft and the second shaft are coaxially arranged.

10. The timepiece according to claim 9, further comprising
a third pointer, wherein
the gear train mechanism comprises a third rotary wheel having a third shaft to which the third pointer is fixed, and
the first shaft, the second shaft, and the third shaft are coaxially arranged.

11. The timepiece according to claim 10, wherein the restriction member is formed of a nonmagnetic material, and includes a restricting portion fixed to the third shaft and disposed on a front surface side of the first magnet.

12. The timepiece according to claim 10, wherein
the first pointer is a minute hand,
the second pointer or the third pointer is an hour hand or a seconds hand, and
at least one of the first pointer, the first shaft, the second pointer, the second shaft, the third pointer, and the third shaft is formed of a nonmagnetic material.
